(19) United States
(12) Patent Application Publication
(10) Pub. No.: US 2010/0028066 A1
(43) Pub. Date: Feb. 4, 2010

(54) PRINTING APPARATUS

(76) Inventor: Matthew Hamilton Thomson, East Kilbride (GB)

Correspondence Address: GIFFORD, KRASS, SPRINKLE,ANDERSON & CITKOWSKI, P.C, PO BOX 7021, TROY, MI, 48007-7021, US

(21) Appl. No.: 12/514,859

(22) PCT Filed: Mar. 14, 2009
(86) PCT No.: PCT/GB08/00923

§ 371 Date: Aug. 13, 2009

(30) Foreign Application Priority Data
Mar. 15, 2007 (GB) 0704950.5

(51) Int. Cl. B41J 11/00

(52) U.S. Cl. 400/621

(57) ABSTRACT

Printing apparatus (S′) comprising printing means (3) having printing means motor (M′₁, M′₂) cutting means (7′) having a cutting means motor (M′₁, M′₂), a means for controlling the printing means motor and the cutting means motor (M′), wherein the control means comprises electronic software and/or firmware, and does not include hardware common to the motors, such as a common shaft drive as in the prior art. The apparatus (S′) also comprises a folding means (7′) having a folding means motor (M′) also controlled by the control means. This arrangement provides a particularly advantageous effect, whereby the motors (M′) are independently driven, but commonly controlled.

### FIELD OF INVENTION

The present invention relates to web processing systems, which may perform operations such as forming an image on a web (e.g. of paper) by printing, copying or another marking process (hereinafter generally referred to as “printing”) and/or handling arrangements such as folding or format adjustment. The present invention is particularly, but not exclusively, concerned with processing systems in which the paper or other material originates as a continuous web on a roll.

The present invention also relates to improvements in and relating to printing machines or apparatus and related methods.

### BACKGROUND TO INVENTION

The known VARIQUIK® system is an offset lithographic (litho) perfecting book signature printing and folding system that takes a reel or web of paper and converts such into a book signature prior to book binding, in any format up to 32 pages, e.g. 16 page or 8 page, depending upon the format, size of fold, section of fold, size of cut-off, etc.

A unique feature of the VARIQUIK® system is that it is a variable size web offset system, which allows different size cut-offs to be printed via three different size print cartridges located in a print tower. Only one of these cartridges drives at any one time. Subsequently the web goes through a common cut-off into a variable size sheet fed folder, from which the folded signature is delivered and stacked, ready to go onto a binding line.

In the known VARIQUIK® system a reel of paper is located into an unwind stand, which holds the reel, allows the reel to rotate, and also controls tension through a friction brake system. It also allows a new reel to be spliced and joined on when an old reel has expired without stopping the press. The paper is then pulled into the machine via an in-feed unit, which is a motor driven steel roller with a rubber nip roller which creates the nip, squeezing onto the paper, and, in use, pulling the paper from the unwind stand, and feeding such towards the print tower. Within the in-feed unit there is a web guidance system that keeps the paper web on or about the centre line of the machine to avoid any sideways variation. Also in the in-feed unit there is a web break detection system, which in the event of a web break puts the machine into an emergency stop mode and stops such rotating, to avoid jam ups, wrap rounds, fires, etc.

Between the in-feed and the print tower there is a set of idler rollers that guide the web towards a base of the print tower. The web then passes vertically through the print tower, and is nipped by whichever cut-off size or print cartridge out of the three which has been selected. The nip is between the blanket cylinders of the print cartridge which, in use, transfers the print onto the paper through the print tower. At the top of the print tower the paper then passes over an air flotation bar, turns 90° to horizontal, passes through an infra-red drying system, which dries and sets the ink, before the paper then turns 90° downwards over two chilled water filled rollers, which then set and bring the paper back down to a normal temperature—approximately room temperature.

After the chill rollers, the paper passes over another web guiding system, which again keeps the paper on or about the centre line of the machine. The web then drops vertically down, then passes horizontally, and then 90° vertical again into the pre-folder, where it optionally passes through a silicone coating unit. This silicone coating unit is an optional unit which may be used for remoisturising the paper. The paper then turns 90° horizontal to come over the top of the pre-folder and onto a former, the former being a triangular shaped item that folds the paper in half about the centre line as a linear fold, before then turning 90° towards a cutter. The paper then passes through an in-feed of the cutter, which can hold an optional perforator and a spine softener which is a water jet that softens the web for folding. The paper goes past anti-static bars and a photo cell, which detects the print to keep the print in register to the cut, so every section is the same and all the pages are in place once folded.

The paper then passes under the cutter. The cutter is a crush cut system, with one knife and three perforators in a drum that rotates, cuts and perforates the web into a sheet before it goes to the folder. After the cutter there is a reject gate which will reject sheets of waste at start-up. Such also rejects sheets for the splice, and is used to stop any bad signatures going into the folding area where the ink can rub off. If the reject gate is closed then the sheeted signature, i.e. the perforated and cut sheet, will then pass across a transfer table into a sheet fed buckle folder where it is folded, e.g. into a 16 page section, which then passes to a knife folder, which then folds the sheet into half, e.g. into 32 pages.

The system described above is the known VARIQUIK® system of the prior art. The product can be delivered without the knife folder as a 16 page landscape, or indeed in other various fold formats. This produces the finished product, which is then passed onto a delivery conveyor and stacked into “logs” ready for the binding line.

Various aspects of the VARIQUIK® system are disclosed in EP 0 246 081 B1, EP 0 459 594 B1, EP 0 459 595 B1, and EP 0 420 297 B1 (STRACHAN HENSHAW MACHINERY LIMITED), the content of all of which are incorporated herein by reference.

To provide a unique feature of the VARIQUIK® system, the variable size cut-off, the print cylinders and respective cartridges, of whatever cut-off circumference (e.g. anything between 860 mm and 1,070 mm circumference in 1 mm increments), and the cut-off knife are driven through a shafted system, which is geared together. The common shafted system which drives the printing cylinders and the cut-off knife, is driven by a DC main motor, which is belt driven between two pulleys to a line shaft. The line shaft comprises three propeller-type shafts linked by gearboxes to the cutter and print cylinder. To put it in other words, the print cylinders and cut-off knife are driven by a common motor which is mechanically linked thereto.

Taking the print cylinders first, from the motor driven pulley, the line shaft passes horizontally along a base of the machine to the base of the print tower, where there is a 90° gearbox, which then changes the direction of the drive vertically through a spline, which passes from the bottom to the top of the printing tower. The print carriage, which traverses up and down the printing tower, carries a female part of the spline within its gearbox. The spline then drives to a single bevel gear, which splits into two bevel gears, which drive out to left and right hand plate rolls via another pair of spline shafts, and a pair of worm wheels which then drive through the centre of the worm wheel, drive the clutch coupling to drive the left and right hand plate cylinders. That is how the print cylinders rotate.

Referring now to the main motor driven pulley, the drive shaft again passes along the base of the machine to a 90° gearbox located at the bottom of the former, and another drive shaft to the base of the cutter unit, where the drive goes through a bevel gearbox, which has a stepper motor and a planetary gear system for phasing the register position. Therefore, the system phases the relative position of the knife to the position of the print. This can change subject to tension, paper substrate, etc, and is an automatic system which monitors the position of the print and changes the position of the knife in order to cut in the correct place. From this gearbox there are two timing belts which drive through a series of timing belt pulleys directly onto the side of the cutter. Thus, for every one revolution of the print cylinder, one revolution of the cutter is made. The paper speed is then controlled by individual draw rolls and the individual servomotors which are ratioed to the speed of the respective print cartridge.

Although the VARIQUIK® printing machine provided a significant improvement to the art, a number of problems have been identified, and a number of improvements can be made. For example, the mechanical drive or “hardware” system has limitations since the register system cannot necessarily keep up—there can be variation in the perforation position, which is generated by increase wear in timing belts, backlash in gearboxes and line shafts, and all the mechanical movement there is between the plate cylinder and the cutter. This leads to accuracy problems and therefore reduces the quality of the work produced on the machine, thereby limiting the marketplace for products of the system. This also gives a reduction in speed therefore limiting the ability to compete against higher speed presses and higher volume machines. Original mechanical driven VARIQUIK® systems typically achieved a maximum of 15,000 impressions per hour.

It is an object of at least one embodiment of at least one aspect of the present invention to seek to obviate or at least mitigate one or more problems/disadvantages in the prior art.

It is an object of at least one embodiment of at least one aspect of the present invention to provide a printing machine which is easier to set up and/or make changes to than in the prior art. This may be important in minimising “down time”, e.g. set up time between different print jobs.

It is an object of the present invention to provide a “shaftless” driven improvement to the VARIQUIK® system with higher accuracy from (AC) servomotors, which may typically provide between 30% and 60% increase in speed and productivity, and preferably with increased accuracy of fold of the product.

It is an object of at least one embodiment of at least one aspect of the present invention to provide an improved printing apparatus or system which disposes with at least one of the shaft drives required in the prior art.

It is an object of at least one embodiment of at least one aspect of the present invention to provide a web-fed printing apparatus capable of achieving over 15,000 impressions per hour (iph), e.g. around 20,000, possibly around 25,000, and perhaps up to 36,000, 37,000 or 40,000.

### SUMMARY OF INVENTION

According to the present invention there is provided the general solution of a printing apparatus or press, such as a web-fed or reel-fed printing apparatus, comprising: a printing means having a printing means motor; a cutting means having a cutting means motor; and means for controlling the printing means motor and the cutting means motor.

The apparatus may also comprise a folding means having a folding means motor.

The control means may control the folding means motor.

The control means may comprise electronic means, control software and/or firmware, and/or electronic circuitry.

Beneficially the control means does not comprise hardware or mechanical linkages or gearing common to the motors, e.g. a shaft drive.

The printing means motor(s) may be provided on a printing medium containing unit moveable, e.g. vertically, on a printing tower.

The arrangement according to the invention provides a particularly advantageous technical effect in that the motors are independently driven, but commonly controlled. This arrangement has been found to provide or address one or more of the objects of the invention mentioned hereinbefore.

The apparatus may comprise an offset lithographic (litho) perfecting printing press e.g. for printing of books. The apparatus according to the invention may be particularly suited to rapid change over from one job to another. The apparatus according to the invention may be particularly suited to short production runs.

The motors may each comprise electronic motors, e.g. AC driven electric motors or servomotors.

According to a first aspect of the present invention there is provided a web-fed printing apparatus comprising means for controlling independently driven motors of or at least one print cartridge and a cutter of the apparatus.

The control means may comprise control electronic means, software means and/or firmware means.

The apparatus may comprise an independently driven motor(s) for at least one print cartridge and an independently driven cutter motor.

The apparatus may comprise a folder, such as a knife folder.

The apparatus may comprise an independently driven folder motor.

The means for controlling the independently driven motors may also control the folder motor.

The motors may each comprise electric motors, e.g. AC electric motors or servomotors.

According to a second aspect of the present invention there is provided a web-fed or reel-fed printing apparatus comprising a print means and a cutting means, wherein the print means and the cutting means are directly driven by respective independent drive means.

These arrangements are particularly beneficial over the prior art since the common (mechanical) shaft arrangement of the prior art is disposed with. In so doing the invention addresses one or more of the objects mentioned hereinbefore.

According to a third aspect of the present invention there is provided a web-fed or reel-fed printing apparatus comprising means for independently drive means or driving motors of one or more than one of:

a printing means;

a cutting means; and/or

a folder means.

Each drive means or driving motor may each comprise an electric motor or AC electric motor or AC servomotor.

Preferably the web-fed or reel-fed printing apparatus of any preceding general solution or aspect is a perfecting printing apparatus, i.e. capable of printing on both sides of the web simultaneously.

The respective drive means or drive motor(s) may be controlled or synchronised electronically (e.g. by electronic, software or firmware synchronisation means),i.e. rather than mechanically.

The print means may comprise a printing tower.

The print means may also comprise cut-off cylinders.

Preferably the apparatus comprises chill rolls and transport drive(s), which are also independently driven by respective independent drive means or drive motors.

Preferably, each of the independent drive means is a motor, and preferably an electric motor, such as an AC electric motor or AC servomotor.

The printing means or print tower may comprise at least one, and preferably a plurality of selectable cartridges, e.g. three print cartridges.

Cylinders of one cartridge may be of a different diameter to cylinder(s) of another cartridge.

The print drive means may be advantageously be provided on the at least one unit. This arrangement is particularly advantageous in providing a cost effective and technically robust apparatus. By such arrangement a print driven means may be provided, which may be selectably moved to a given cartridge. The print drive means may comprise a pair of motors.

According to a fourth aspect of the present invention there is provided a web-fed printing apparatus comprising a knife folder, the knife folder comprising a drive means and a knife blade, wherein the drive means comprises or provides a lobed or eccentric cam or drive member.

The drive means may comprise a drive device (or prime mover), and a drive mechanism connecting the drive device to the knife blade.

The lobed cam or drive member may comprise at least part of the drive mechanism.

Preferably the lobed cam or drive member comprises a first portion and a second portion, the second portion being narrower in width than the first portion.

Preferably the first portion is connected to the drive device and the second portion is connected to the knife blade.

The knife folder may also comprise a plunger. The drive mechanism may connect the drive device to the plunger. In use, the plunger may be caused to move or reciprocate in a linear (e.g. vertical) movement.

The cam/drive member provides particular advantage in increasing the speed of the knife folder. This also decreases the cycle time of the knife folder over that prior art. This is at least partially due to the reduction in inertia of the cam/drive member in comparison to the prior art.

Preferably the lobed cam or drive member is substantially solid—having no holes or recess (with the possible exception of those required to connect the lobed cam to the drive device and to the knife blade).

The lobed cam may be rotatable around an axis, such as a horizontal axis, which axis may be in a plane of the knife-blade.

The apparatus of any preceding general solution or aspect may comprise a web-fed printing apparatus comprising:

a plurality of printing cartridges arranged in a fixed array for printing a web feedable through each cartridge of the array; optionally

at least one unit for containing printing medium mounted adjacent the array; and optionally

(drive) means for moving the at least one unit from a position in which it interacts with one of the cartridges to a position in which it interacts with another of the cartridges, preferably altering a variable cutoff as it does so; optionally

whereby, in use, a web fed through the array is printable by a selected cartridge, that selected cartridge interacting with the at least one unit and its transfer means transferring the printing medium from the at least one web, and the selected cartridge is optionally changeable by operation of the drive means to move the at least one unit from the selected cartridge to another cartridge.

Cylinders of one cartridge may be of a different diameter to printing cylinder(s) of another cartridge.

The print drive means may be advantageously be provided on the at least one unit or a carriage moveable relative to the cartridges.

The carriage may carry first and second driving and/or inking units or cylinders. The damping and inking units may be driven by independently driven third and fourth print drive means motors.

The carriage may carry first and second print means motors for driving rollers of the selected cartridge.

Each cartridge may comprise a pair of blanket cylinders and a pair of plate cylinders.

The first and second print means motors may each have associated male or female portions matable with a complementary female or male portion on the cartridges. By such arrangement the selected cartridge may be engaged with the first and second print means motors.

The apparatus/cartridge may form a web-fed offset printing press, in which each cartridge may have a pair of blanket cylinders, and a corresponding pair of plate cylinders. The common unit may then be an inking and dampening unit displaceable relative to the cartridges to supply selectively the plate cylinders of at least one of those cartridges. Thus, it becomes possible to have a printing sequence that can be varied in detail in which the following features can be carried out: the inking and dampening unit is placed in an operative position for a first cartridge and a print run is carried out for that cartridge; then the blanket cylinders of the first cartridge are moved away from the web; the blanket cylinders of a second cartridge (which has different characteristics such as the nature of the image, the image pitch or colour) are moved into contact with the web when the inking and dampening unit has moved to that cartridge. A new printing run can thus be started at the second cartridge with very little time delay. It then becomes possible to change, e.g. the image on a plate cylinder of the first cartridge, whilst the printing machine is running.

The apparatus may include a plurality of inking and dampening units for supplying respective different colours simultaneously to a plurality of selected cartridges (with in general, at least an equal plurality of cartridges not then, being supplied). There may be a plurality of arrays or stacks with driers interposed as required, or a system in which the cartridges can be exchanged for others stored elsewhere.

The apparatus of any preceding general solution or aspect may comprise a web-fed perfecting printing apparatus comprising:

an array of cartridges for printing on a web fed through the array, each cartridge comprising a pair of adjacent printing cylinders, and each cylinder of a cartridge being adapted to apply printing medium to a respective surface of a web passing therebetween; optionally

means for supplying a printing medium to both printing cylinders of a selected cartridge said printing medium supplying means being contained in one or more discrete units; and optionally

means for effecting mutual repositioning of the cartridges with respect to the or each printing medium supply unit to effect the selection of said selected cartridge wherein the web is fed through each cartridge of the array.

The apparatus of any preceding general solution or aspect may comprise a web-fed printing apparatus comprising a plurality of cartridges in an array for printing a web feedable through the array, each cartridge having means for transferring printing medium for a unit for containing such printing medium to the web, the means including at least one printing cylinder which is adapted to contact the web; wherein the at least one printing cylinder of one of the cartridges has a different circumference from that of the at last one printing cylinder of at least one other of the cartridges, such that, in use, the different sized cylinders provide printing of respectively different print repeat lengths, and the web is printed by at least some of the cartridges with the different sized cylinders being simultaneously present in the apparatus during that printing; wherein the cartridges are arranged so that the web is feedable through each cartridge of the array.

With the present invention, it is possible for the printing to change from one repeat length to another without having to break the web.

The apparatus of any preceding general solution or aspect may comprise a web processing system comprising an apparatus for printing continuously at least one web of material; means for transferring the printed web continuously to a means for cutting the web into a plurality of separate sheets, which cutting means has an action having a timed relationship with the printing apparatus; and means for transferring the sheets continuously to a means for folding the sheets, wherein the folding means has an action which is timed in dependence on the arrival of a sheet at the folding means and independently of the action of printing on the at least one web.

The web processing system may have means between the printing apparatus and the cutting means for forming a longitudinal fold in the or each web.

The apparatus may comprise a web processing system comprising an apparatus for printing at least one web of material; means for forming a longitudinal fold in the or each web; means for cutting the web into a plurality of separate sheets; and means for folding the sheets; wherein the folding means has an action which is timed in dependence on the arrival of a sheet at the folding means and independently of the action of printing on the at least one web.

The web processing system may have means for forming a longitudinal perforation in the or each web prior to the formation of the longitudinal fold.

The web processing apparatus or system of any preceding general solution or aspect may have means for forming a transverse perforation in the web prior to cutting of the web into sheets.

The apparatus may comprise a processing system comprising: an apparatus for printing at least one web of material; means for forming a transverse perforation in the or each web; means for cutting the web into a plurality of separate sheets; and means and independently of the action of printing on the at least one web.

The means for folding the sheets may include a buckle folder.

Between the cutting means and the means for folding the sheets, means may be provided for directing alternate sheets to a corresponding one of two folders of the folding means.

By the above arrangement the invention may provide web printing and sheet folding with a folder whose action is defined in dependence on arrival of a sheet (e.g. buckle folder or knife folder). There may therefore be provided continuous movement of the web from printer to folder, which may form a longitudinal fold and form perforations in the web. This arrangement of features provides particularly beneficial advantage.

The apparatus of any preceding general solution or aspect may comprise a web processing system comprising an apparatus for printing continuously at least one web of material; means for transferring the printed web continuously to a means for cutting the web into a plurality of separate sheets, which means has an action having a timed relationship with the printing apparatus; and means for transferring the sheets continuously to a means for folding the sheets, which folding means has an action which is timed in dependence on the arrival of a sheet at the folding means and independently of the action of printing on the at least one web.

The apparatus of any preceding general solution or aspect may comprise a web processing system comprising: an apparatus for printing at least one web of material; means for forming a longitudinal fold in the or each web; means for cutting the web into a plurality of separate sheets; and means for folding the sheets, which folding means has an action which is timed in dependence on the arrival of a sheet at the folding means and independently of the action of printing on the at least one web.

The apparatus of any preceding general solution or aspect may comprise a web processing system comprising: an apparatus for printing at least one web of material; means for forming a transverse perforation in the or each web; means for cutting the web into a plurality of separate sheets, and means for folding the sheets, which folding means has an action which is timed in dependence on the arrival of a sheet at the folding means and independently of the action of printing on the at least one web.

The apparatus of any preceding general solution or aspect may, in use print at least 15,000 impressions per hour, e.g. at least 20,000 impressions per hour.

According to a fifth aspect of the present invention there is provided a method of processing at least one web comprising the step of:

providing a web-fed printing apparatus according to any of the general solution or the first, second or third aspects of the present invention; and

processing or printing upon the at least one web by using said apparatus.

The method may comprise a method of processing at least one web of material comprising printing on the at least one web; cutting, in a timed relationship with the printing, the or each printed web into a plurality of separate sheets; and folding each sheet by a folding means; there being continuous movement of the material from prior to the printing to the commencement of the folding of the sheets; wherein the folding means has an action which is timed in dependence on the arrival of a sheet at the folding means and independently of the action of printing on the at least one web.

The method may comprise a method of processing at least one web of material, comprising printing on the at least one web; forming a longitudinal fold in the or each printed web; cutting, in a time relationship with the printing the or each web into a plurality of separate sheets; and folding each sheet by a folding means, wherein the folding means has an action which is timed in dependence on the arrival of a sheet at the folding means and dependently of the action of printing on the at least one web.

The method may comprise a method of processing at least one web of material, comprising printing the at least one web; forming transverse perforations in the printed web; cutting in a timed relationship with the printing, of the or each web into a plurality of separate sheets; and folding each sheet by a folding means, wherein the folding means has an action which is timed in dependence on the arrival of a sheet at the folding means and independently of the action of printing on the at least one web.

The method of the preceding aspect may comprise a method of processing at least one web of material comprising printing on the at least one web; cutting, in a timed relationship with the printing, the or each printed web into a plurality of separate sheets; and folding each sheet by a folder whose action is timed in dependence on the arrival of a sheet at the folder and independently of the action of printing on the at least one web; wherein there is continuous movement of the material from prior to the printing to the commencement of the folding of the sheets.

The method of the preceding aspect may comprise a method of processing at least one web of material comprising printing on the at least one web; forming a longitudinal fold in the or each printed web; cutting, in a timed relationship with the printing, the or each web into a plurality of separate sheets; and folding each sheet by a folder whose action is timed in dependence on the arrival of a sheet at the folder and independently of the action of printing on the at least one web.

The method of the preceding aspect may comprise a method of processing at least one web of material, comprising printing the at least one web; forming transverse perforations in the printed web; cutting, in a timed relationship with the printing, of the or each web into a plurality of separate sheets; and folding each sheet by a folder whose action is timed in dependence on the arrival of a sheet at the folder and independently of the action of printing on the at least one web.

### BRIEF DESCRIPTION OF DRAWINGS

An embodiment of the present invention will now be described by way of example only, and with reference to the accompanying drawings, which are:

FIG. 1(a) a general view of a web-fed printing apparatus according to the prior art;

FIGS. 1(b) and (c) schematic diagrams of printing apparatus illustrating the difference between non-perfecting and perfecting printing;

FIG. 2 a printing unit comprising part of the apparatus of FIG. 1;

FIG. 3 an overall schematic planar view of a web-fed printing apparatus according to the prior art with shaft drive;

FIG. 4 a schematic view of the prior art apparatus of FIG. 3;

FIG. 5 an overall schematic planar view of a web-fed printing apparatus according to an embodiment of the present invention with shaftless drive;

FIG. 6 a schematic view of the apparatus of FIG. 5;

FIG. 7 an overall perspective view of the apparatus of FIG. 5 showing web to sheet feeding;

FIG. 8 a schematic view of part of the apparatus of FIG. 5 comprising a printing tower having an independently driven shaftless motor;

FIG. 9 a schematic view of part of the apparatus of FIG. 5 comprising a cutter having an independently driven shaftless motor;

FIG. 10(a) to (f) a series of views of a knife arrangement with lobed cam comprising part of the apparatus of FIG. 5;

FIGS. 11(a) and (b) timing diagrams for the knife arrangement of FIGS. 10(a) to (f); and

FIGS. 12(a) to (d) schematic diagrams for control software for independently driven motors of the apparatus of FIG. 5.

### DETAILED DESCRIPTION OF DRAWINGS

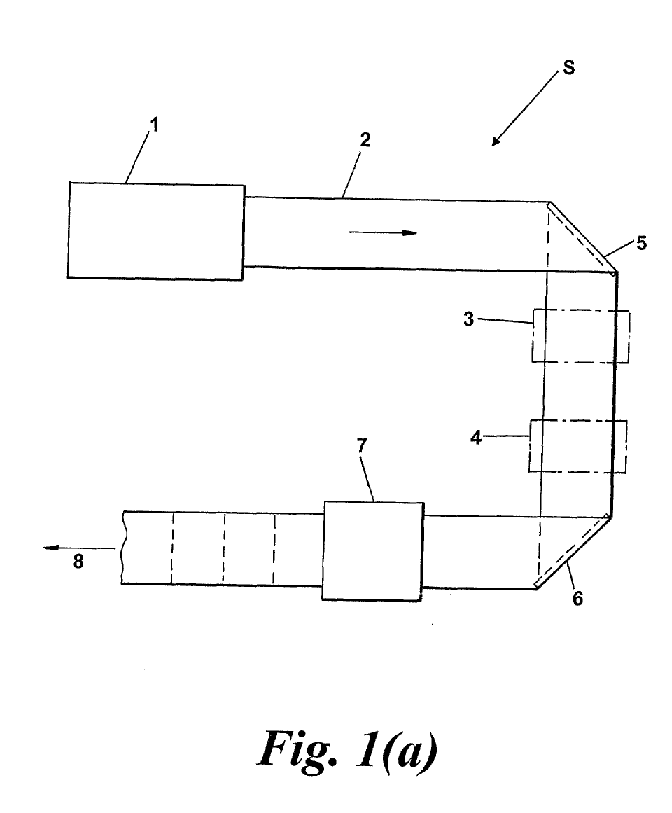

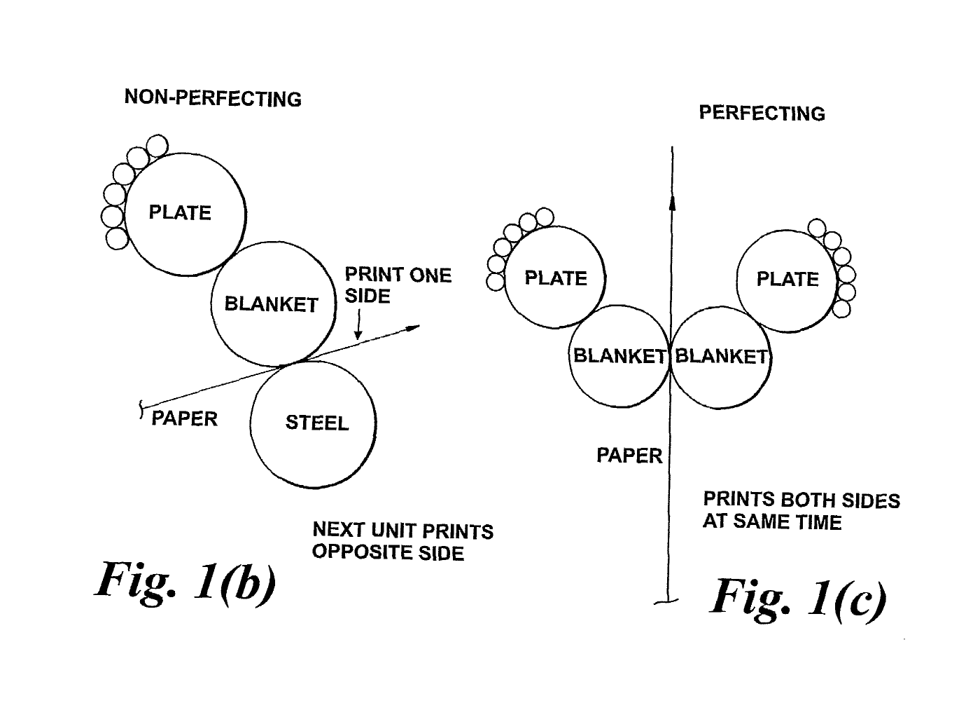

Referring initially to FIG. 1, there is shown a web handling system or printing apparatus, generally designated S, according to the prior art, but useful in the present invention. The system S involves three parts. In this example the web is paper. A first part, generally indicated 1, takes paper from one or more paper rolls in the form of a web 2 and transports such to a printing unit 3, and an optional drying unit 4. As illustrated in FIG. 1, a right-angled 90° turn in the paper web 2 is achieved by passing the paper round an angled bar 5. After passing through the printing unit 3, and then the drying unit 4, the paper web 2 is again turned for convenience through a further right-angled 90° turn via a further bar 6 and passed to a cutting and folding arrangement generally indicated 7. Sheets of paper printed, cut and folded as appropriate then pass, e.g. for stacking, in a direction indicated by arrow 8. Of course, any arrangement of paper web input unit 1, printing station 3, drying station 4, and cutting and folding arrangement 7 may be provided, the actual configuration depending on space and similar constraints.

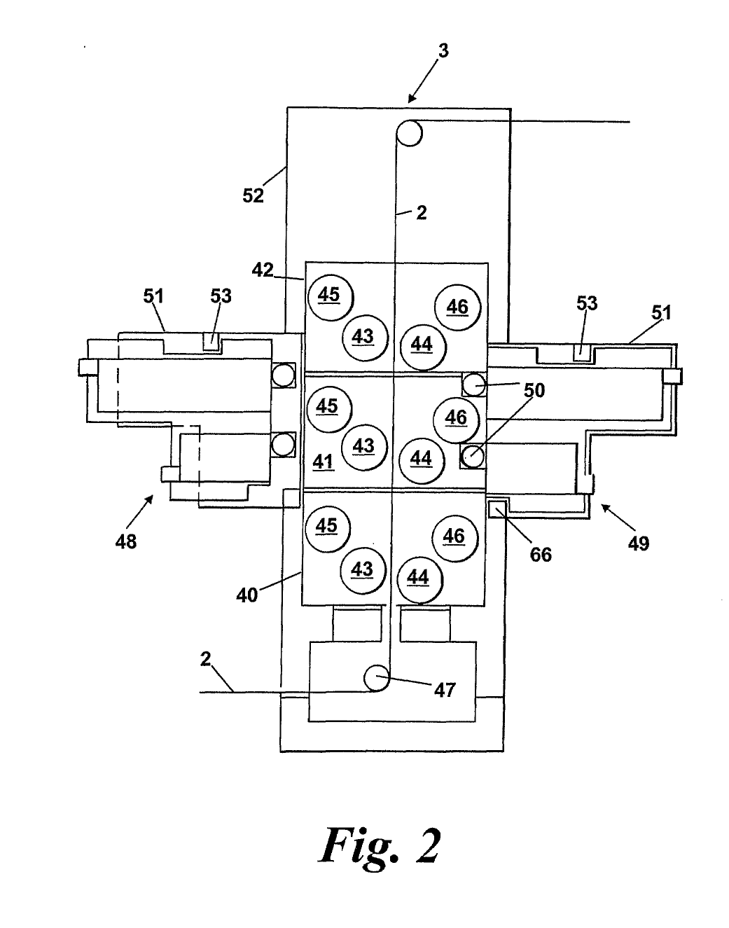

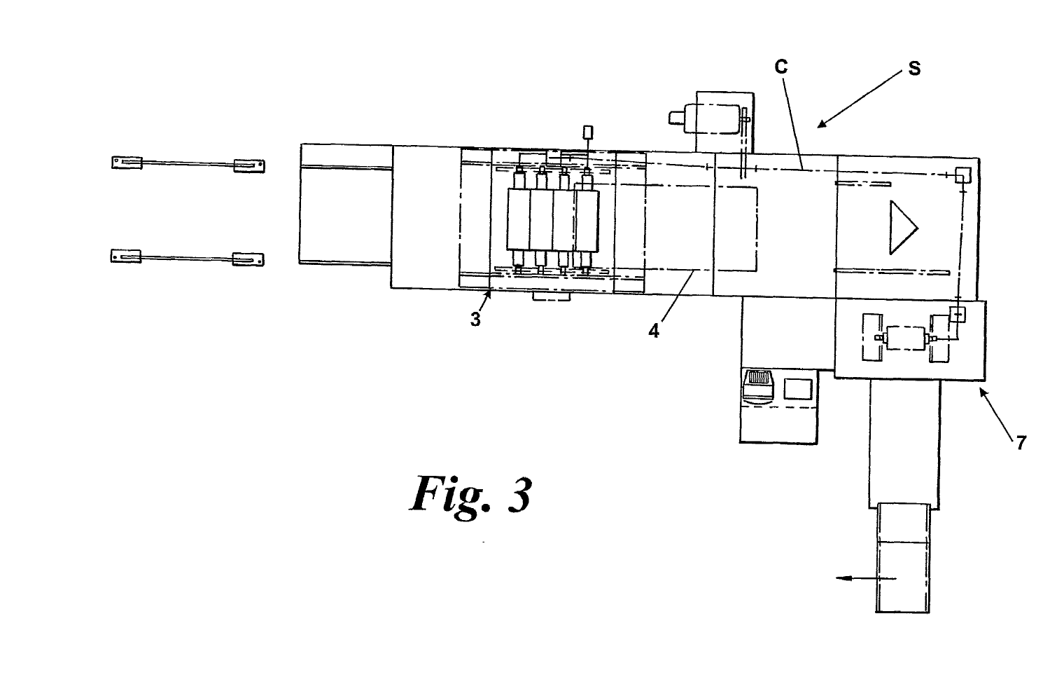

As explained, with reference to FIG. 1, the paper web 2 passes to a printing unit 3. FIG. 2 illustrates such a unit 3 being a web-fed offset lithographic perfecting press according to the prior art, but useful in the present invention.

Referring briefly to FIGS. 1(b) and (c), these illustrate the difference between non-perfecting and perfecting printing, respectively. In non-perfecting printing two sequential print units are provided (only one of which is shown), one for one side of the web, and one for the other side of the web. In perfecting printing two print units are provided, which print on respective sides of the web simultaneously.

As illustrated in FIG. 2, the printing unit or press 3 has three cartridges 40,41,42, with each cartridge having a pair of blanket cylinders 43,44, in blanket-to-blanket configuration, and a pair of plate cylinders 45,46 the outer surface of each of which is formed by a printing plate in contact with a corresponding one of the blanket cylinder 43,44, i.e. each cartridge contains a “printing couple”. Normally the plate and blanket cylinders 45, 46; 43, 44; have the same diameter, but it is also known to have plate cylinders of half the circumference of the corresponding blanket cylinder. As illustrated, the cartridges 40,41,42 are immediately adjoining each other, as this gives the array of cartridges 40,41,42 a small size. It would be possible, however, for the cartridges 40,41,42 to be in a spaced-apart array. The web 2 passes round a roller 47 and between the pair of blanket cylinders 43,44 of each cartridge 40,41,42. It is preferable if the cartridges 40,41,42 are stacked substantially vertically, but substantially horizontal arrangements are also possible, including arrangements in which the cartridges are movable transverse to the web. The image to be printed on the web 2 is carried on the plate cylinders 45,46, and transferred via the blanket cylinders 43,44—hence “offset” printing to the web. As shown in FIG. 2, a unit containing printing medium, e.g. an inking and dampening train 48,49 is provided on each side of the web 2. The inking and dampening trains 48,49 are capable of moving vertically separately or together, and each may contain throw-off mechanisms to facilitate that vertical movement (compare trains 48 and 49).

When printing is to occur, the inking and dampening trains 48,49 are moved in the vertical direction to register with one of the cartridges 40,41,42. The inking and dampening rollers 50 are brought into contact with the plate cylinders 45,46 by means of mechanisms, which ensure correct operating geometries and pressures. As illustrated, the inking and dampening trains 48,49 are provided on each side of the web 11, but are common to all three cartridges 40,41,42. If the cartridge 41 is to print, the trains 48,49 are operated so that the inking and dampening rollers 50, move into contact with the two plate cylinders 45,46 of that cartridge 41. A printing run then occurs. At the end of that printing run, the inking and dampening trains 48,49 are moved to their thrown-off configurations (as shown for 48), and the trains 48,49 are moved vertically until they are adjacent one of the other two cartridges 40,42. By moving the inking and dampening roller 50 into contact with the plate cylinders 45,46 of another cartridge 40 or 42, a new print sequence can operate.

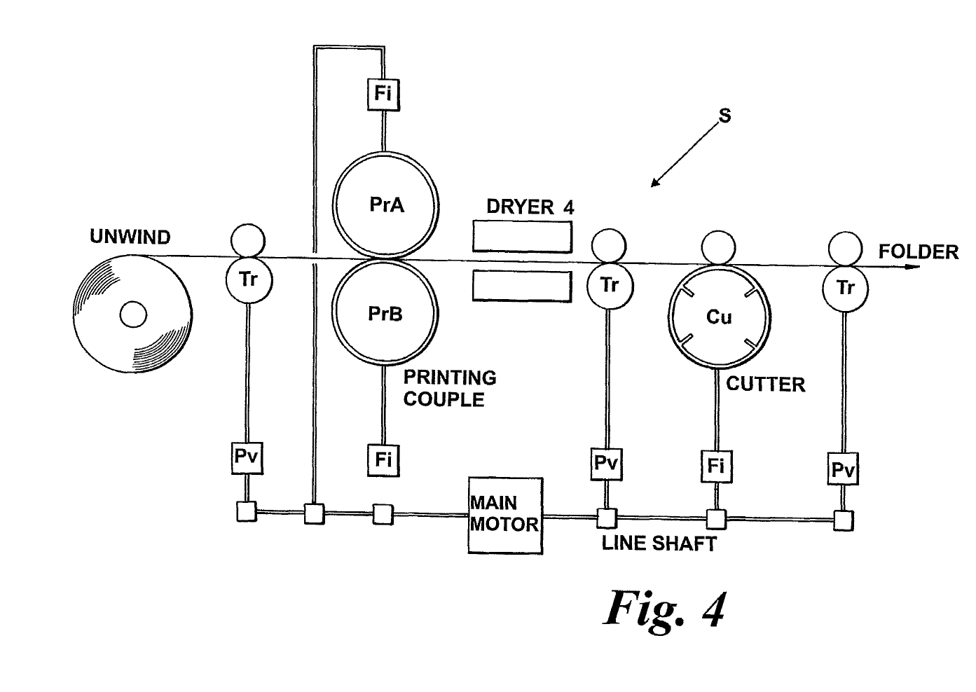

Referring now to FIGS. 3 and 4, there are shown views of a web-fed printing apparatus S according to the prior art, including a common shaft drive system C between the print cylinders and the cut-off knife. The common shaft drive system C provides “hardware” means for controlling the print cylinders and the cut-off knife. This arrangement is that described hereinbefore in the section headed “Background to Invention”.

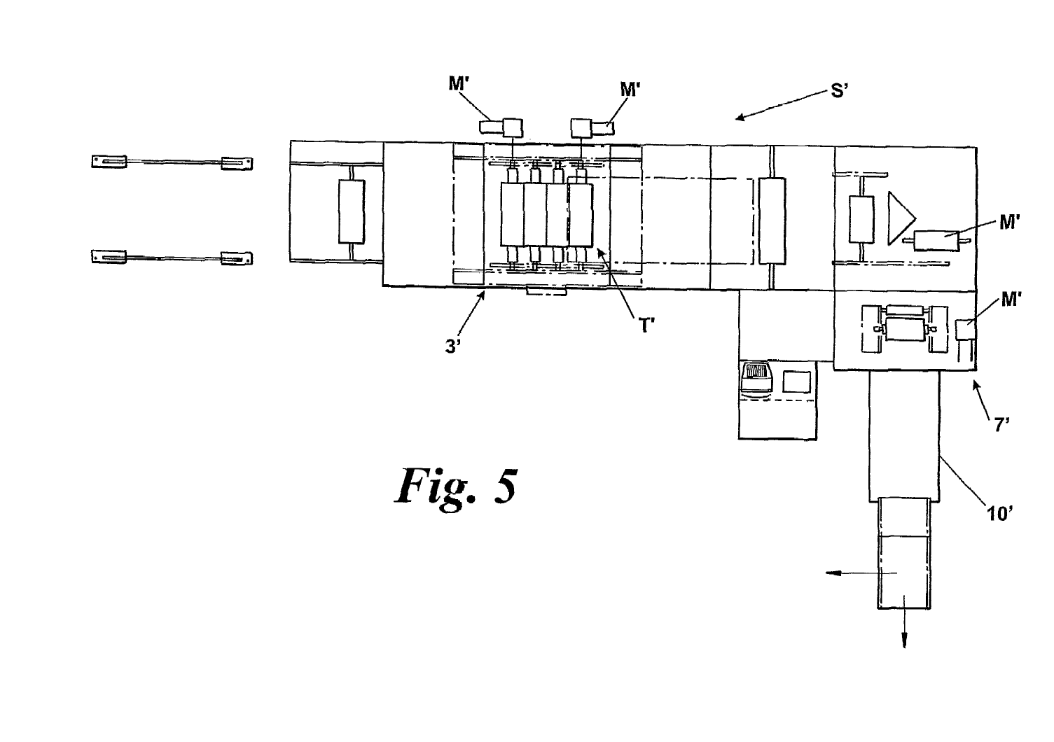

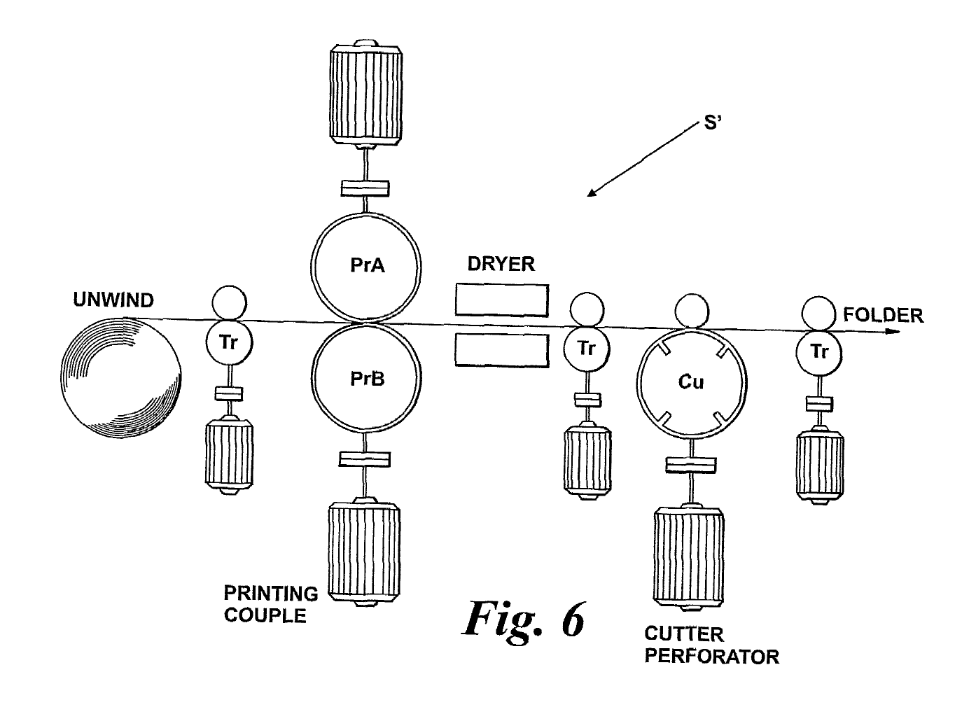

Referring now to FIGS. 5 and 6, there is shown a web-fed printing apparatus, generally designated S′, according to the present invention. Like parts of the apparatus S are designated by the same letters/numerals as the apparatus S of the prior art of FIGS. 1 to 4, but suffixed “′”.

With the apparatus S′ there is no fundamental change to the finished product, or the way that the web passes through the apparatus S′ or machine. What has been changed is that the drive system to the print cylinders and the cut-off cylinder has been improved by removing the main DC motor, all the line shafts, the worm and wheels, and the timing belt drive to the cutting head. These have been replaced with individual AC drive synchronised servomotors directly on the left and right hand plate cylinder and on the cut-off cylinder linked to a worm and wheel gearbox, all to the same specification, and fitted or bolted directly onto the apparatus S′. The individual motors drive through a clutch coupling onto the cut-off cylinder, and are controlled by a drive system and a p1c system.

An overview of the shaftless litho press of the invention is shown in FIGS. 5 and 6.

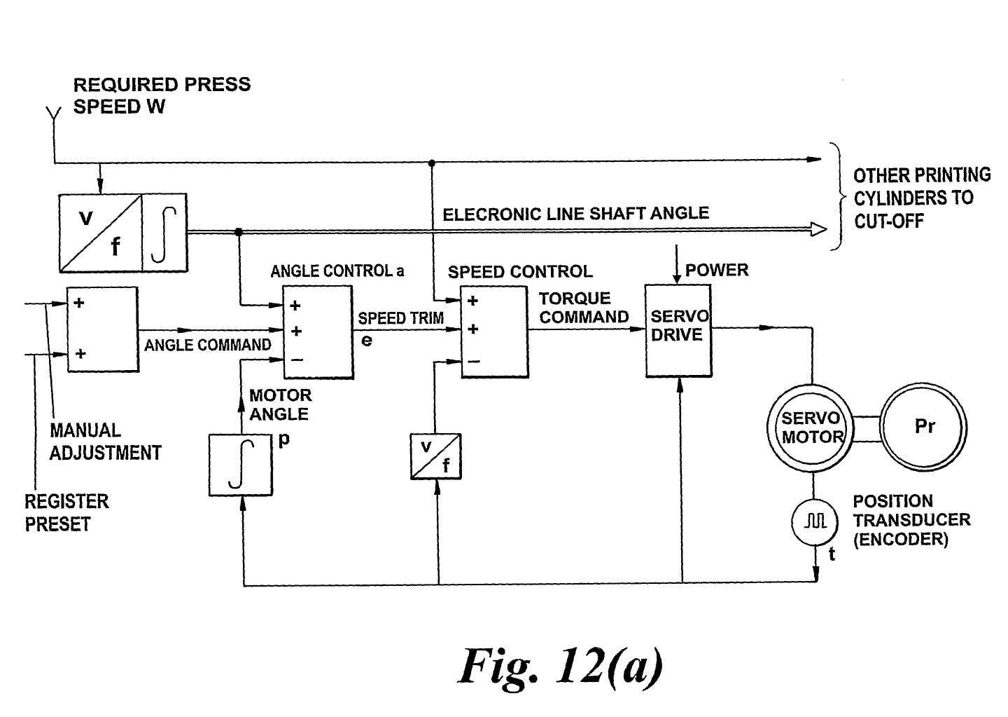

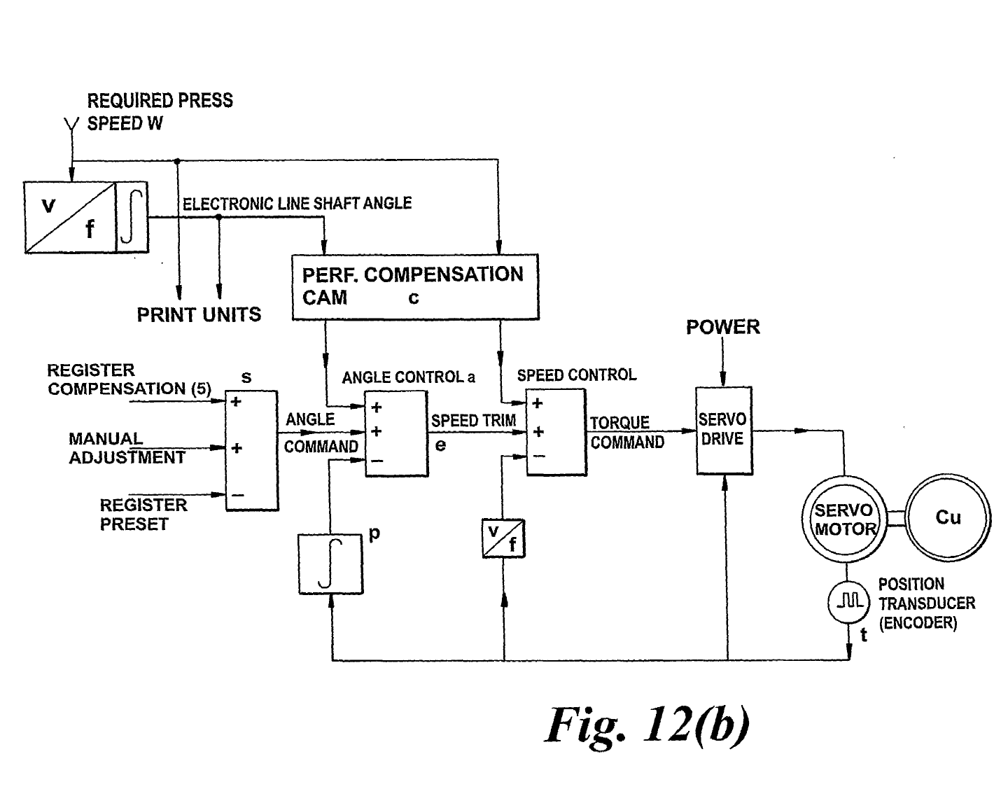

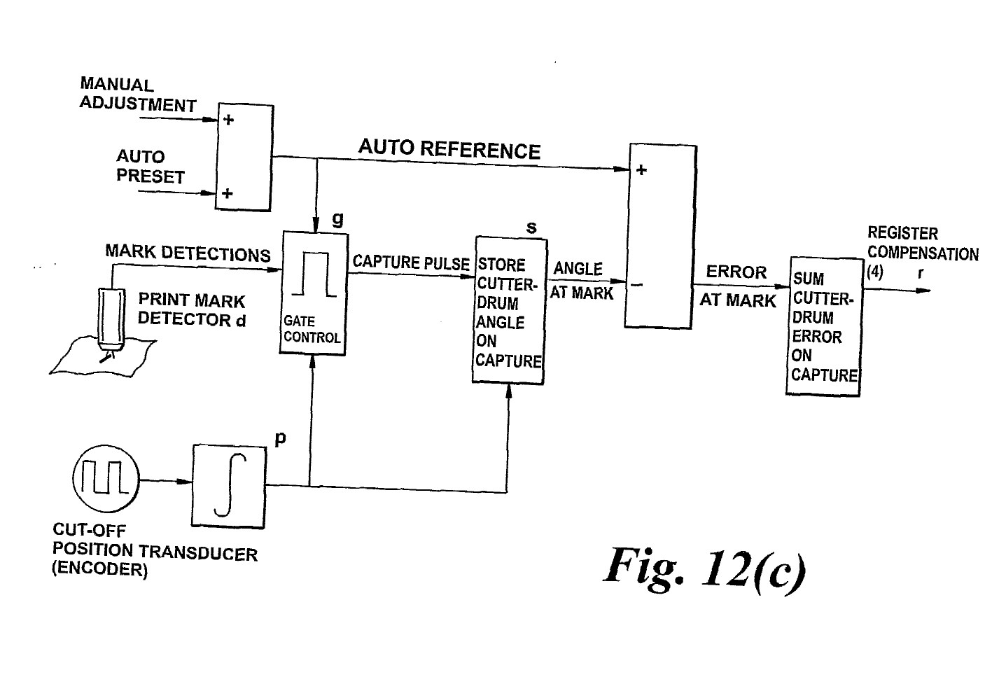

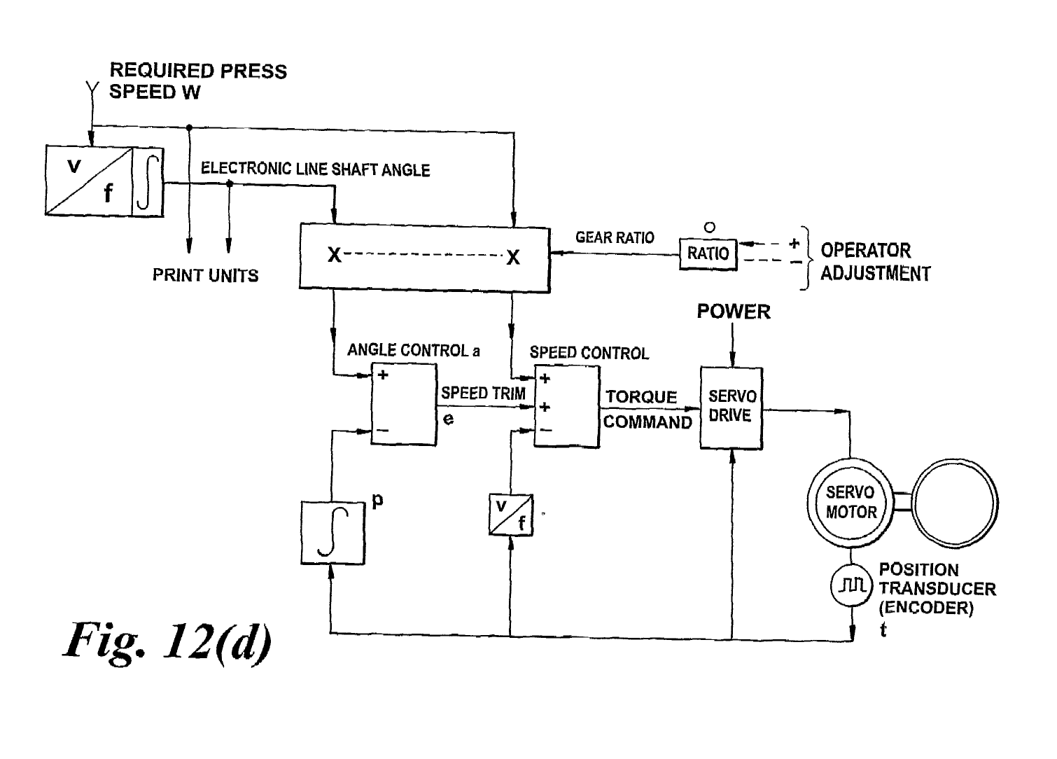

A control system for the shaftless press is described and shown in FIG. 12(a) to (d). The control system independently controls each of the AC servo motors.

The web-fed printing apparatus S′ comprises a print means 3′ and a cutting means 7′, wherein the print means 3′ and the cutting means 7′ are directly driven by respective independent drive means M′.

This arrangement is particularly beneficial over the prior art since the common shaft arrangement of the prior art may be disposed with.

The respective drive means M′ are synchronised electronically (by electronic synchronisation means) rather than mechanically. The print means 3′ comprises a printing tower and cut-off cylinders.

The apparatus 5′ comprises chill rolls and transport drive(s), which are also independently driven by respective independent drive motors. Each of the independent drive means M′ is a motor, and advantageously an electric motor. The print tower comprises at least one, and preferably a plurality of selectable cartridges T′, e.g. three print cartridges tT′.

The web-fed printing apparatus S′ comprises a knife folder 10′, the knife folder 10′ comprising a drive means M′ and a knife blade 12′, the drive means M′ being connected to the knife blade 12′, the drive means M′ providing a lobed cam 14′.

The drive means M′ comprises a drive device 16′ and a drive mechanism 18′. The knife folder 10′ also comprises a plunger 20′. The drive mechanism 18′ connects the drive device 16′ to the plunger 20′.

The lobed cam 14′ provides particular advantage in increasing the speed of the knife folder 10′. This also decreases the cycle time of the knife folder 10′ over that of the prior art. This is at least partially due to the reduction in inertia of the lobed cam 14′ in comparison to the prior art.

The web-fed printing apparatus S′ comprises means for controlling independently driven motors M of a print cartridge T′ and a cutter 7′ of the apparatus.

The control means may comprise control electronic and/or software means. Alternatively the control means may comprise firmware means.

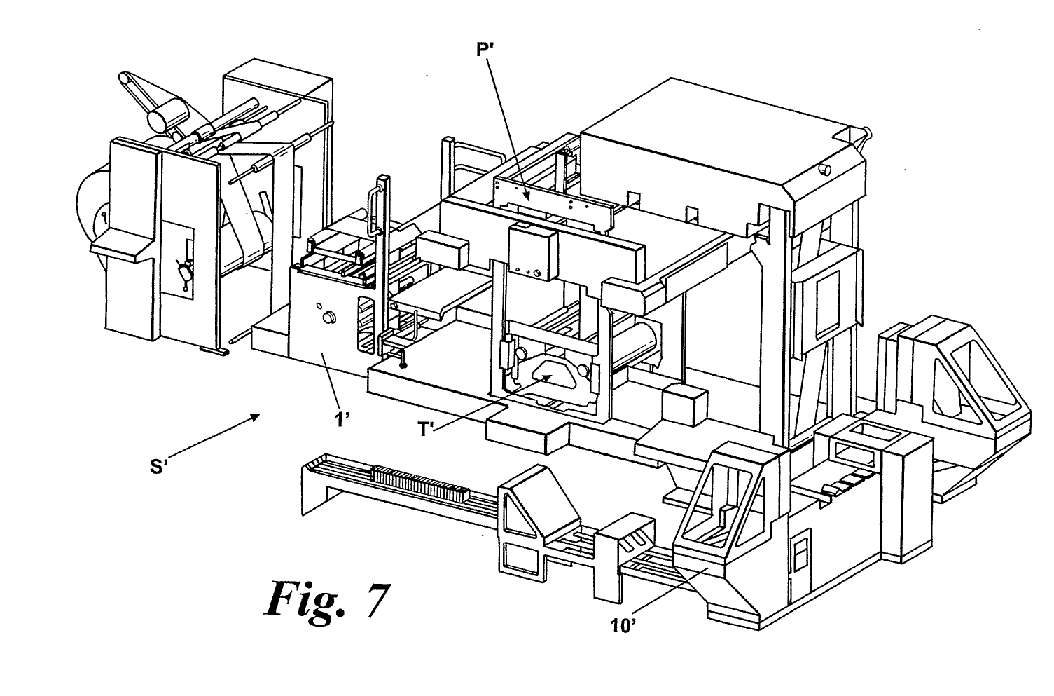

FIG. 7 shows an overview of the press apparatus S′ with the unwind moving onto the in-feed unit 1′ of the print tower, with one print cartridge tT″ located in the bottom, the print carriage parked at the top position, the infra-red drier shown mounted at the bottom of the press, the chill roll unit below such, the web passing into the bore former, around to the cut-off unit, the transfer table passing to the buckle folder, and finally showing a stacker binder at the end on the 32 page delivery.

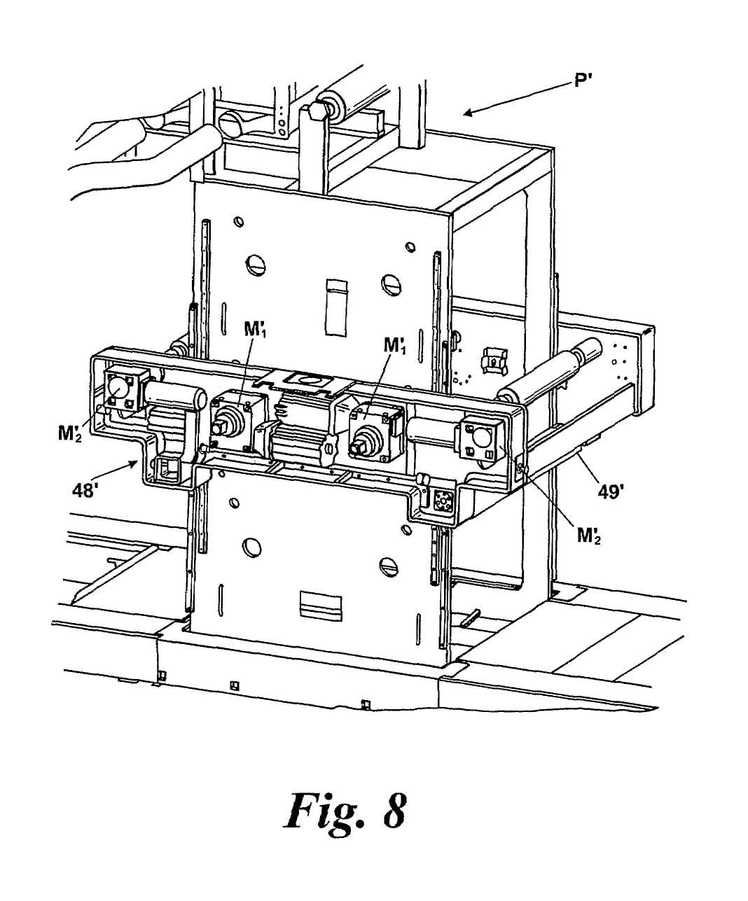

Referring to FIG. 8, which shows the drive side of the print tower P′, the independently driven plate roll motors M′₁ are the motor gearboxes that are opposed to each other. The independently driven inking motors M₂ motor gearboxes are shown in the view. Such drive the ink fountain roll. All the motors are electronically synchronised.

Turning now to the motors M′₁ for the plate cylinders. These are mounted in the back as can be seen, and they are driven through a clutch assembly. Air cylinders on the back of the gearbox, fire the clutches in and out of the print tower P′, onto the back of a coupling on each plate cylinder. This is in three positions—the upper and lower positions (the holes can be seen), where the female part of the clutch mounted in the gearbox passes through and locates onto the male part of the clutch on the back of each print cylinder. There are therefore two female portions—one for each motor M′₁, and in this embodiment six male portions are on each of the plate rollers of the three cartridges.

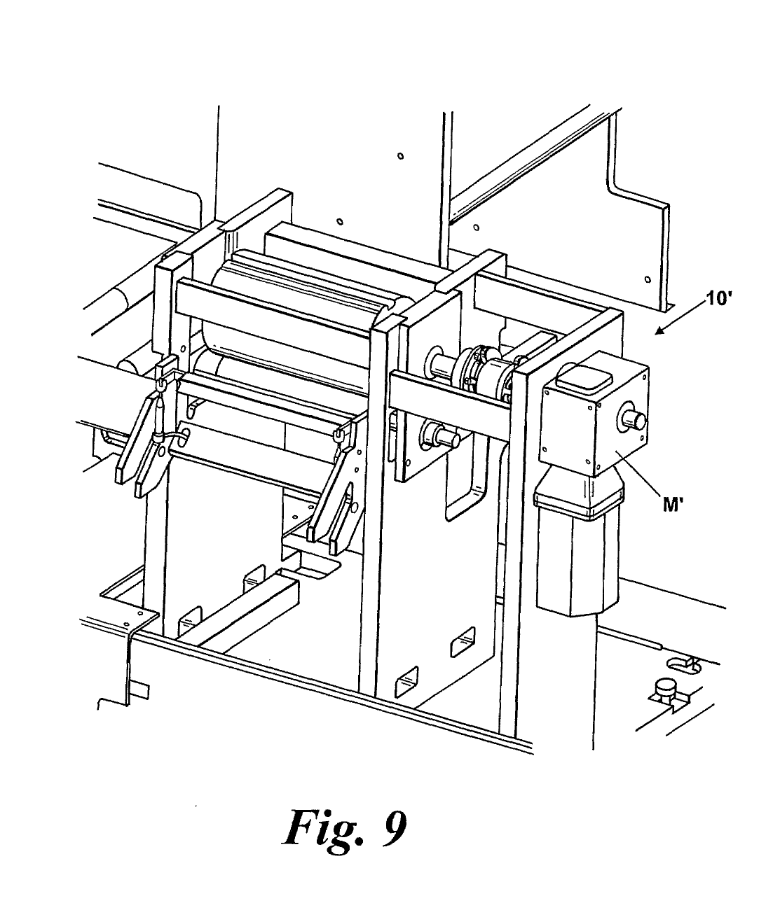

Turning now to FIG. 9, which shows a cutting head where the cylinder in the centre holds the knife and up to three perforators or cutting off from web to sheet. This is driven again with an independent motor gearbox mounted on the side, through a flexible coupling directly driven onto the knife roll. An anvil roll comprising a hardened chrome anvil which creates the crush cut is then belt driven (not shown), that is the roll directly below the knife cylinder is belt driven, to then rotate and perform the crush cut and crush perforation action of the cut-off cylinder, which is timed electronically to the plate cylinder and then trimmed to allow accurate registration of the print to the cut, and therefore aligning the pages when the book is completed.

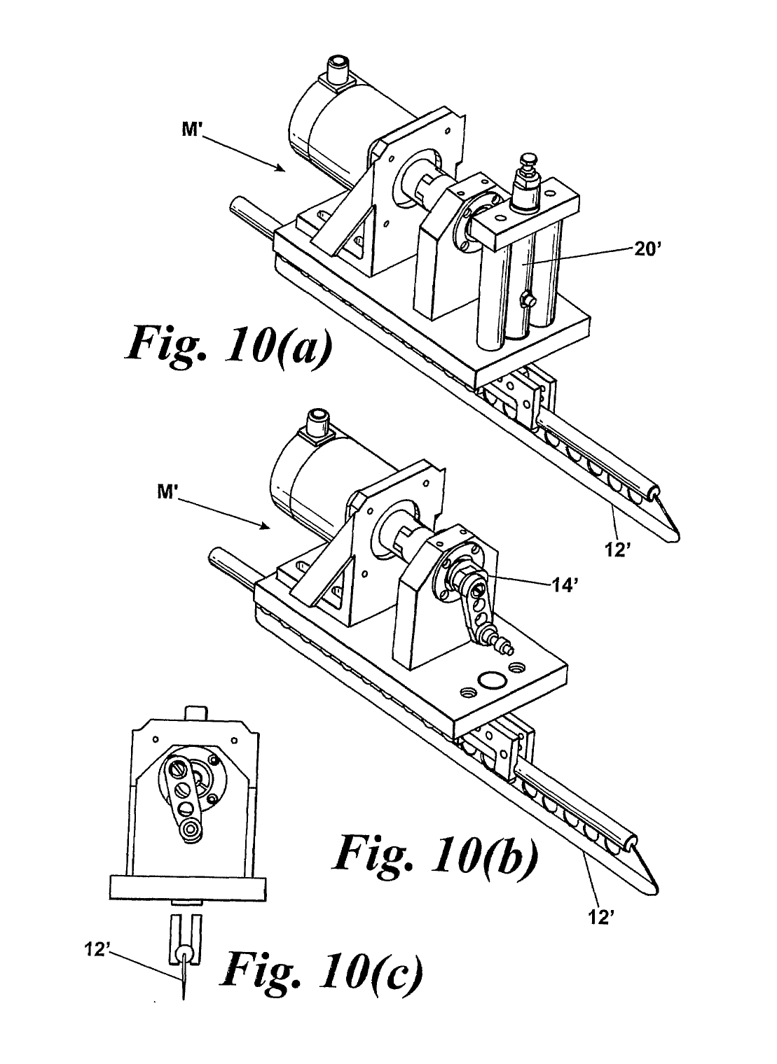

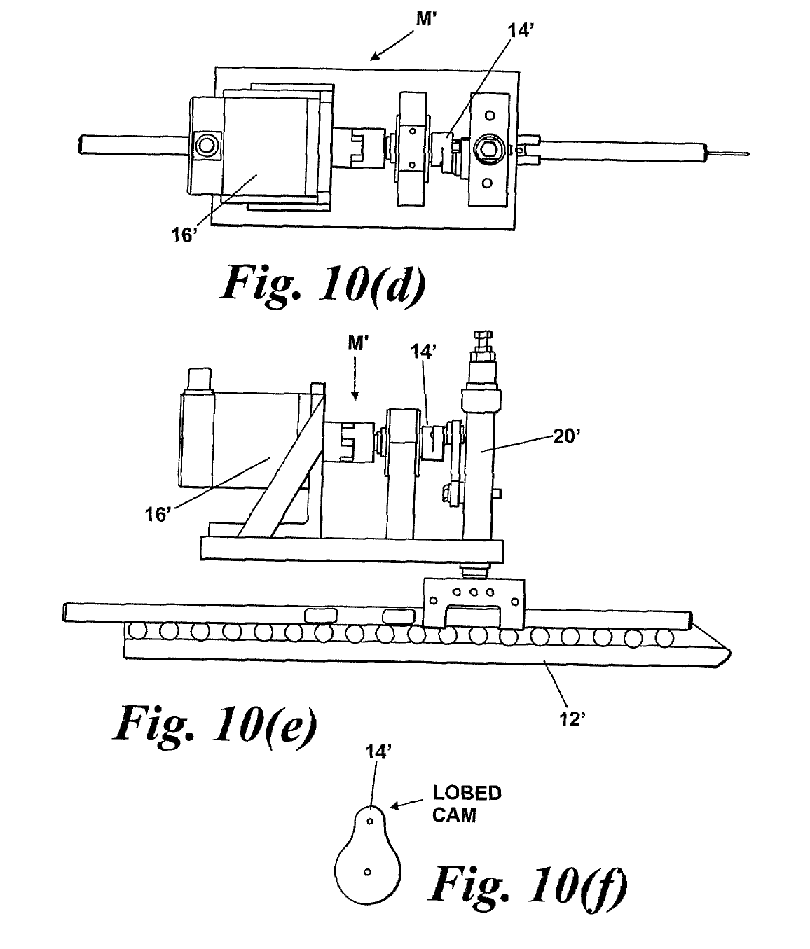

Referring to FIGS. 9 and 10(a) to (f) of the knife folder 10′, the knife folder 10′ sits after a buckle folder and is the final cross fold for the signature to produce the 32 page product, the action directly onto the paper being the knife drop. The knife fold action arises from the blade 12′ moving through a vertical down and return up movement, dropping onto the centre perforation of the signature, presenting the signature into a double set of nip rolls below, which pushes it through, creates the fold, and then returns to its home position and waits for the next signature to come. When a photocell senses a signature, it fires again. The drive set up for the knife fold originally consisted of a stepping motor driving a flexible coupling to a bearing assembly, which drives a hub, a full diameter hub with an outer ring for another proximity switch to detect mounted on the outside of it, and then through a pinion screwed at a radius from a centre onto the hub. The linear linkage then links to the vertical plunger of the knife fold. Hence, when the motor is triggered, one revolution of this hub then takes the plunger down to its nip position, then returns it home. The ring with the screw on the outside for the proximity switch locates the home position for the stepper motor for the drive to recognise that is was home.

The invention provides improvements to the known VARIQUIK® system, which had an original speed limitation of around 15,000 impressions an hour. The Applicant has changed the function and specification to increase the speed. The Applicant has changed the drive and the stepping motor to increase the rotational output and accuracy of the motor. This in itself increased speed, but then to reduce the inertias of the rotary to linear linkage the full circumference hub and ring have been replaced with a lobed cam 14′. The lobed cam 14′ sits in exactly the same place as the original hub, but has a lot less mass, and therefore reduces the inertias in the rotary to linear mechanism, making it smoother and enabling us to achieve a mechanical speed of 37,000 impressions per hour. The increase in speed of the actual product being folded has been achieved because the cycle time, not necessarily just the number of impressions it is available to do, it is the cycle time of the one revolution has also been decreased.

The increase in speed of the machine through the improvements of the knife fold is not only due to the faster and bigger motor allowing it to run faster, it is also due to the cycle time so that one can clear each signature through the rollers quickly to make time and space for the next signature to come along under the knife, and have the knife back in the parked position. This has gone from somewhere in the region of a cycle time of one hundred and eighty milliseconds to achieve the 15,000 an hour and to reduce down to 90 milliseconds, which enables us to run the machine up to 40,000 an hour.

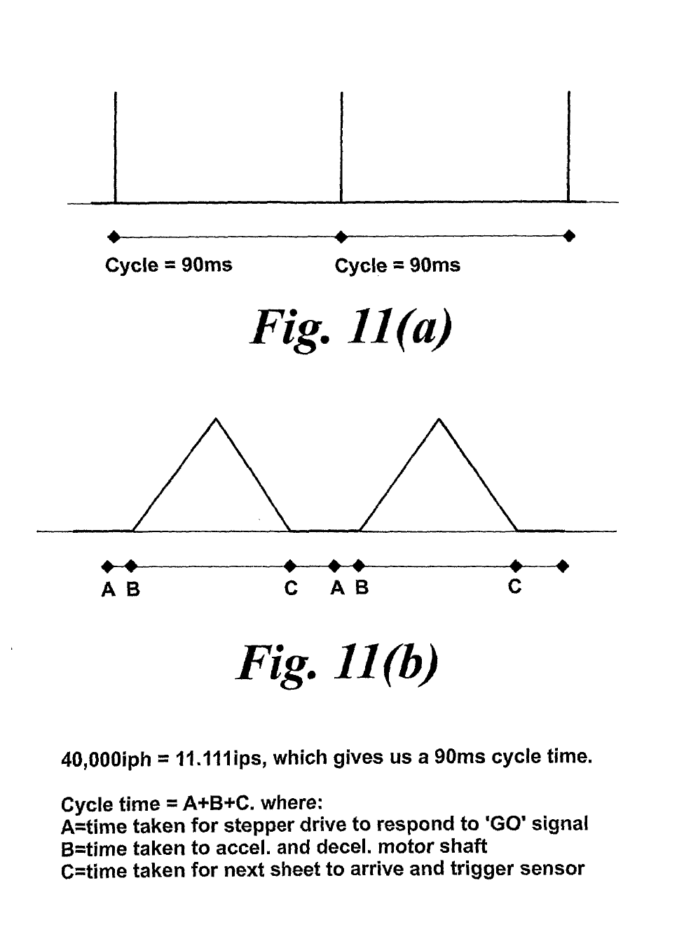

Referring to FIGS. 11(a) and (b), the required operating cycle of the knife is detailed below:
40,000 iph=11.111 ips (where iph/ips=impressing per hour/second), which gives a 90 ms cycle time.

Cycle time=A+B+C, where:
A=time taken for stepper drive to respond to ‘GO’ signal;
B=time take to accelerate and decelerate motor shaft;
C=time taken for next sheet to arrive and trigger sensor.

The hatched area indicates the part of the cycle where the knife is below the surface of a table.

FIG. 4 shows a conventional litho press. It is only intended to illustrate the principle drive-elements of the press, the printing-couple shown as a pair of cylinders (PrA & PrB) is in fact an assembly of plate, blanket and ink cylinders. Only one printing-couple is shown, several could be needed for colour printing. All of the cylinders are driven from one LINE SHAFT.

The “in register” printing cylinders and cutter-drum (Cu) run at the same speed as the line-shaft, but they can be phased with respect to the line-shaft by differential gearboxes Fi. The operator will adjust the phase to achieve correct print and cut-off register

The “paper-transport” cylinders (Tr) control tension through the press. Their speed can be changed (by a small amount) using the PIV gearboxes Pv.

FIG. 6 shows the same press but converted to “shaftless” operation according to the present invention. All of the rolls are driven by individual motors. Whilst the electronic control-system emulates the basic operation of a line-shaft press, mechanical complexity is reduced, removal of the line-shaft improves precision, and the system 5′ is more flexible. It is easier to automate control and preset of register.

FIG. 12(a) shows the basic electronic control-system for the press. The required press-speed W is used to generate an “electronic line-shaft angle”. This angle is analogous to the line-shaft angle of a conventional press. Consider a conventional press with the line-shaft geared one-to-one with the prints. If a 0-360 degree scale is engraved around the line-shaft circumference, the number read off this scale by a fixed pointer is analogous to the electronic line-shaft angle.

Angle of the print-roll is calculated by counter p. Pulses from a shaft-encoder t are counted, the count being zeroed every time that the motor is at its datum-angle.

The angle-control block a compares electronic-line-shaft angle, motor angle and angle-set-point to generate an “angle error”. This error is scaled and limits-checked to generate the “speed-trim” e. If, for example, the motor is lagging behind its required phase with the electronic line-shaft, e will be positive, and the motor will run faster to “catch up”.

The angle command is the sum of manual (operator adjust) angle and the “register preset” angle. The “register preset” angle is calculated for each print cartridge to achieve the correct back-to-front and colour-to-colour register.

This description is intended to convey the principles of the control means or system. In practice, the electronic line-shaft angle is very precise, a count of 65536 represents one revolution; and the motor-angle is measured to a similar precision using an arc-cosine encoder.

FIG. 12(b) shows an electronic control-system for a cut-off. A cut-off drum is normally fitted with one knife-bar and several perforator bars. The control-system normally works to ensure good registration between cut-off and print. The perf-compensation CAM c allows a small amount of “eccentricity” to be added into the cut-off rotation to achieve good perforation registration.

The angle-command summer s adds in a compensation-term from the cut-off register-loop explained in the next section.

FIG. 12(c) shows a cut-off register loop. The print-mark detector d is an optical contrast-sensor which turns ON when dark printed marks pass under its scanning eye. The product is printed with a “register-mark”. This is a rectangular mark a fixed distance from the cut-off point. It is also arranged that there are no other print-marks within the scanning-field of the detector in, and within 100 mm of the register-mark.

Gate-control g rejects print-mark detections other than those within plus/minus 100 mm of the expected detection point.

Block s reads the cutter-drum angle at each capture pulse (i.e. at every mark-detection which passes through the gate-control block). This angle is compared with the required angle to generate an “error at mark”.

An “error at mark” is added into the register-compensation signal r and passed to the cutting-drum control-loop.

FIG. 12(d) shows a paper-transport cylinder control. Similar angle-control techniques are used to achieve extremely precise speed-ratio control. Operators can make small adjustments to the gear-ratio at block o.

The shaftless technology used in the present invention is adapted to be used in an apparatus having variable cut-off and different sized print cylinders. The shaftless technology has been adapted in respect of the original ratio control for the different sized cut-offs, and customised to suit this function. The drive control system is told via a binary code or set of links in the cartridge as to which position the cartridge is in on the machine, the operator through a preset in the operator configuration files, the electronic system knows the circumference of the cylinder being run. The lead print cylinder independent motor then turns that plate cylinder at a speed; the opposing print cylinder and cutter are then matched to that speed; and then the transport rollers carrying the paper are then ratioed to produce the correct metres per minute to feed the right amount of paper per revolution as per the circumference of the printing cylinder.

It will be appreciated that the embodiment of the present invention hereinbefore described is given by way of example only and is not meant to limit the scope of the invention in any way.

The invention provides an elegant solution to various problems in the art, such as accuracy, speed, and/or reliability. The invention replaces a common DC motor and mechanised linkage for synchronised control of various units with distinct AC motors commonly controlled, e.g. by electronics and/or software. The invention is particularly advantageous for relatively short run and/or fast changeover book printing.

1. A printing apparatus, particularly a web-fed or reel-fed printing apparatus, comprising:
a printing means having at least one printing means motor;
a cutting means having at least one cutting means motor; and
means for controlling the at least one printing means motor and the at least one cutting means motor, wherein
the at least one printing means motor is provided on a carriage comprising a printing medium containing unit, the carriage being movable on a printing tower having a plurality of selectable cartridges, the at least one print means motor being provided on the carriage.

2. A printing apparatus as claimed in claim 1, wherein the apparatus comprises a folding means having at least one folding means motor.

3. A printing apparatus as claimed in claim 2, wherein the control means controls the at least one folding means motor.

4. A printing apparatus as claimed in claim 1, wherein the control means comprises electronic means.

5. A printing apparatus as claimed in claim 1, wherein the motors are independently driven, but commonly controlled.

6. A printing apparatus as claimed in claim 1, wherein the apparatus comprises an offset lithographic perfecting printing press.

7. A web-fed or reel fed printing apparatus comprising means for controlling independently driven motors of at least one print cartridge and a cutter of the printing apparatus, wherein the independently driven motors comprise at least one printing means motor and at least one cutting means motor, wherein
the at least one printing means motor is provided on a carriage comprising a printing medium containing unit, the carriage being movable on a printing tower having a plurality of selectable cartridges, the at least one print means motor being provided on the carriage.

8. A printing apparatus as claimed in claim 7, wherein the control means is selected from one or more of: control electronic means, software means, and firmware means.

9. A printing apparatus as claimed in claim 7, wherein the apparatus comprises an independently driven print cartridge motor, and an independently driven cutter motor.

10. A printing apparatus as claimed in claim 7, wherein the apparatus comprises a folder, such as a knife folder.

11. A printing apparatus as claimed in claim 10, wherein the apparatus comprises an independently driven folder motor.

12. A printing apparatus as claimed in claim 10, wherein the means for controlling the independently driven motors also controls the folder motor.

13. A web-fed or reel-fed printing apparatus comprising a print means and a cutting means, wherein the print means and the cutting means are directly driven by respective independent drive means, wherein the independently driven means comprise at least one printing means motor and at least one cutting means motor, wherein
the at least one printing means motor is provided on a carriage comprising a printing medium containing unit, the carriage being movable on a printing tower having a plurality of selectable cartridges, the at least one print means motor being provided on the carriage.

14. A web-fed or reel-fed printing apparatus comprising means for independently driving motors of one or more than one of:
a printing means;
a cutting means; and/or
a folder means, wherein
the at least one printing means motor is provided on a carriage comprising a printing medium containing unit, the carriage being movable on a printing tower having a plurality of selectable cartridges, the at least one print means motor being provided on the carriage.

15. A printing apparatus as claimed in claim 7, wherein the web-fed or reel-fed printing apparatus is a perfecting printing apparatus, each motor comprising an electric motor, such as an AC electric motor or AC servomotor.

16. A printing apparatus as claimed in claim 7, wherein the respective drive means are synchronised electronically such as by electronic, software and/or firmware means.

17. A printing apparatus as claimed in claim 7, wherein the print means comprises a printing tower.

18. A printing apparatus as claimed in claim 7, wherein the printing or print means also comprises cut-off cylinders.

19. A printing apparatus as claimed in claim 7, wherein the apparatus comprises chill rolls and transport drive(s), which are independently driven by respective independent drive means.

20. A printing apparatus as claimed in claim 7, wherein each of the independent drive means or motors is selected from one of: an electric motor, such as an AC electric motor and a servomotor.

21. A printing apparatus as claimed in claim 7, wherein the printing means or print tower comprises at least one or a plurality of selectable cartridges.

22. A printing apparatus as claimed in claim 1, comprising a knife folder, wherein the knife folder comprises a drive means and a knife blade, wherein the drive means comprises a lobed or eccentric cam or drive member.

23. A printing apparatus as claimed in claim 22, wherein the drive means comprises a drive device and a drive mechanism connecting the drive device to the knife blade, the lobed cam or drive member comprising at least part of the drive mechanism.

24. A printing apparatus as claimed in claim 22, wherein the lobed or eccentric cam or drive member comprises a first portion and a second portion, the second portion having a width less than a width of the first portion.

25. A printing apparatus as claimed in claim 23, wherein the first portion is connected to the drive device and the second portion is connected to the knife blade by a rigid member which comprises one or more recesses or apertures.

26. A printing apparatus as claimed in claim 22, wherein the knife folder also comprises a plunger, which is connected to a/the rigid member.

27. A printing apparatus as claimed in claim 26, wherein the drive mechanism connects the drive device to the plunger, the plunger being caused, in use, to move or reciprocate in a linear movement.

28. A printing apparatus as claimed in claim 22, wherein the lobed or eccentric cam or drive member is solid.

29. A printing apparatus as claimed in claim 7, wherein the apparatus comprises a web-fed printing apparatus comprising:
a plurality of printing cartridges arranged in a fixed array for printing a web feedable through each cartridge of the array; optionally
at least one unit for containing printing medium mounted adjacent the array; and optionally
means for moving the at least one unit from a position in which it interacts with one of the cartridges to a position in which it interacts with another of the cartridges, preferably altering a variable cutoff as it does so; optionally
whereby, in use, a web fed through the array is printable by a selected cartridge, that selected cartridge interacting with the at least one unit and its transfer means transferring the printing medium from the at least one web, and optionally the selected cartridge is changeable by operation of the drive means to move the at least one unit from the selected cartridge to another cartridge, and further optionally
printing cylinder(s) of one cartridge are of different diameters to printing cylinder(s) of another cartridge.

30. A printing apparatus as claimed in claim 29, wherein the apparatus or cartridge forms a web-fed offset printing press, in which each cartridge has a pair of blanket cylinders, and a corresponding pair of plate cylinders.

31. A printing apparatus as claimed in claim 30, wherein the apparatus comprises an inking and dampening unit displaceable relative to the cartridges to supply selectively the plate cylinders of at least one of those cartridges.

32. A printing apparatus as claimed in claim 31, wherein, in use, the apparatus provides a printing sequence, wherein: the inking and dampening unit is placed in an operative position for a first cartridge and a print run is carried out for that cartridge; then the blanket cylinders of the first cartridge are moved away from the web; the blanket cylinders of a second cartridge are moved into contact with the web when the inking and dampening unit has moved to that cartridge.

33. A printing apparatus as claimed in claim 29, wherein the apparatus includes a plurality of inking and dampening units for supplying respective different colours simultaneously to a plurality of selected cartridges.

34. A printing apparatus as claimed in claim 1, wherein the apparatus comprises a web-fed perfecting printing apparatus comprising:
an array of cartridges for printing on a web fed through the array, each cartridge comprising a pair of adjacent printing cylinders, and each cylinder of a cartridge being adapted to apply printing medium to a respective surface of a web passing therebetween; optionally
means for supplying a printing medium to both printing cylinders of a selected cartridge said printing medium supplying means being contained in one or more discrete units; and optionally
means for effecting mutual repositioning of the cartridges with respect to the or each printing medium supply unit to effect the selection of said selected cartridge wherein the web is fed through each cartridge of the array.

35. A printing apparatus as claimed in claim 7, wherein the apparatus comprises a web-fed printing apparatus comprising a plurality of cartridges in an array for printing a web feedable through the array, each cartridge having means for transferring printing medium for a unit for containing such printing medium to the web, the means including at least one printing cylinder which is adapted to contact the web; wherein the at least one printing cylinder of one of the cartridges has a different circumference from that of the at least one printing cylinder of at least one other of the cartridges, such that, in use, the different sized cylinders provide printing of respectively different print repeat lengths, and the web is printed by at least some of the cartridges with the different sized cylinders being simultaneously present in the apparatus during that printing; wherein the cartridges are arranged so that the web is feedable through each cartridge of the array.

36. A printing apparatus as claimed in claim 7, wherein, in use, the apparatus is capable of providing the printing to change from one repeat length to another without having to break the web.

37. A printing apparatus as claimed in claim 7, wherein the apparatus comprises a web processing system comprising an apparatus for printing continuously at least one web of material; means for transferring the printed web continuously to a means for cutting the web into a plurality of separate sheets, which cutting means has an action having a timed relationship with the printing apparatus; and means for transferring the sheets continuously to a means for folding the sheets, wherein the folding means has an action which is timed in dependence on the arrival of a sheet at the folding means and independently of the action of printing on the at least one web.

38. A printing apparatus as claimed in claim 37, wherein the web processing system has means between the printing apparatus and the cutting means for forming a longitudinal fold in the or each web.

39. A printing apparatus as claimed in claim 7, wherein the apparatus comprises a web processing system comprising an apparatus for printing at least one web of material; means for forming a longitudinal fold in the or each web; means for cutting the web into a plurality of separate sheets; and means for folding the sheets; wherein the folding means has an action which is timed in dependence on the arrival of a sheet at the folding means and independently of the action of printing on the at least one web.

40. A printing apparatus as claimed in claim 38, wherein the web processing system has means for forming a longitudinal perforation in the or each web prior to the formation of the longitudinal fold.

41. A printing apparatus as claimed in claim 7, wherein the web processing apparatus has means for forming a transverse perforation in the web prior to cutting of the web into sheets.

42. A printing apparatus as claimed in claim 7, wherein the apparatus comprises a processing system comprising: an apparatus for printing at least one web of material; means for forming a transverse perforation in the or each web; means for cutting the web into a plurality of separate sheets; and means and independently of the action of printing on the at least one web.

43. A printing apparatus as claimed in claim 42, wherein the means for folding the sheets includes a buckle folder.

44. A printing apparatus as claimed in claim 42, wherein between the cutting means and the means for folding the sheets, means are provided for directing alternate sheets to a corresponding one of two folders of the folding means.

45. A printing apparatus as claimed in claim 44, wherein there is provided web printing and sheet folding with a folder whose action is, in use, defined in dependence on arrival of a sheet.

46. A printing apparatus as claimed in claim 42, wherein there is provided continuous movement of the web from printer to folder, which forms a longitudinal fold and forms perforations in the web.

47. A printing apparatus as claimed in claim 7, wherein the apparatus, in use, produces at least 15,000 or at least 20,000 impressions per hour.

48. A method of processing at least one web comprising the steps of:
providing a web-fed printing apparatus according to claim 7; and
processing the at least one web by using said apparatus.

49. The method of claim 48, wherein the method comprises a method of processing at least one web of material comprising printing on the at least one web; cutting, in a timed relationship with the printing, the or each printed web into a plurality of separate sheets; and folding each sheet by a folding means; there being continuous movement of the material from prior to the printing to the commencement of the folding of the sheets; wherein the folding means has an action which is timed in dependence on the arrival of a sheet at the folding means and independently of the action of printing on the at least one web.

50. The method of claim 48, wherein the method comprises a method of processing at least one web of material, comprising printing on the at least one web; forming a longitudinal fold in the or each printed web; cutting, in a time relationship with the printing the or each web into a plurality of separate sheets; and folding each sheet by a folding means, wherein the folding means has an action which is timed in dependence on the arrival of a sheet at the folding means and dependently of the action of printing on the at least one web.

51. The method of claim 48, wherein the method comprises a method of processing at least one web of material, comprising printing the at least one web; forming transverse perforations in the printed web; cutting in a timed relationship with the printing, of the or each web into a plurality of separate sheets; and folding each sheet by a folding means, wherein the folding means has an action which is timed in dependence on the arrival of a sheet at the folding means and independently of the action of printing on the at least one web.

52. A printing apparatus as claimed in claim 4, wherein the electronic means is selected from one or more of: control software, firmware, and electronic circuitry.

53. A printing apparatus as claimed in claim 6, wherein the motors are selected from one of: electronic motors, AC electric motors and AC servomotors.

54. A printing apparatus as claimed in claim 9, wherein the print cartridge motor is an AC motor and the cutter motor is an AC motor.

55. A printing apparatus as claimed in claim 11, wherein the folder motor is an AC motor.
